(19) United States
(12) Patent Application Publication
(10) Pub. No.: US 2026/0227265 A1
(43) Pub. Date: Aug. 6, 2026

(54) DIAGNOSIS SYSTEM AND PROCESSING DEVICE

(71) Applicant: HITACHI INDUSTRIAL EQUIPMENT SYSTEMS CO., LTD., Tokyo (JP)

(72) Inventors: Masashi KONO, Tokyo (JP); Yusuke NAKAGAWA, Tokyo (JP)

(73) Assignee: HITACHI INDUSTRIAL EQUIPMENT SYSTEMS CO., LTD., Tokyo (JP)

(21) Appl. No.: 19/152,744

(22) PCT Filed: Nov. 30, 2023
(86) PCT No.: PCT/JP2023/042886

§ 371 Date: Jul. 31, 2025

(30) Foreign Application Priority Data
Feb. 15, 2023 (JP) 2023-021846

(51) Int. Cl. G01M 3/02; G01M 99/00; G01N 15/08

(52) U.S. Cl. CPC G01M 3/025; G01M 99/005; G01N 15/08; G01N 2015/084

(57) ABSTRACT

This diagnosis system diagnoses a monitoring target instrument by using a computer comprising a processor and a memory. The processor: receives operation data that contains the control which has been performed periodically over the monitoring target instrument, and the running time of the instrument which has been run according to said control; and gives a diagnosis of abnormality with respect to the instrument in an inefficient operation state, on the basis of a determination as to whether or not a prescribed relationship is satisfied between the control and the running time of the instrument contained in the operation data.

### TECHNICAL FIELD

The present invention relates to a diagnosis system for diagnosing a plurality of monitoring target instruments, and a processing device.

### BACKGROUND ART

In recent years, with the progress of global warming, efforts have been made to realize a decarbonized society that achieves virtually zero CO2 emissions. Services that remotely visualize operation states of instruments and presence/absence of occurrence of abnormalities are becoming more widespread, using remote monitoring systems that use the Internet of Things (IOT) cloud to constantly monitor industrial instruments. However, industrial instruments that emit a large amount of CO₂ require energy conservation efforts.

Conventionally, technology disclosed in Patent Document 1 has been known as technology related to a monitoring device that reduces the processing load of an instrument. Patent Document 1 discloses an invention related to a monitoring system for a compressor that can monitor a remaining lifespan of a semiconductor element of a motor control device while reducing the processing load, including a compressor body driven by a motor to compress gas, and a pressure sensor provided on a discharge side of the compressor body to detect the pressure of the compressed gas, wherein at least one of a motor controller and an operation controller outputs a command to a display device to indicate that the remaining lifespan or a consumed lifespan of the semiconductor element has reached a predetermined threshold value.

### CITATION LIST

### Patent Document

Patent Document 1: JP 2021-072708 A

### SUMMARY OF THE INVENTION

### Problems to be Solved by the Invention

Patent Document 1 discloses technology that includes an operation controller configured to switch between loaded operation and unloaded operation based on pressure detected by a pressure sensor, and stops a compressor body by stopping a motor. However, there is no description of a method of extracting inefficient operation of a monitoring target instrument. In order to reduce CO₂ emissions from an industrial instrument, it is necessary not only to control stoppage of the instrument, but also to efficiently operate the instrument while considering a viewpoint of energy saving.

An object of the invention is to provide technology for diagnosing an abnormality in an instrument in an inefficient operation state based on operation data of the instrument.

### Solutions to Problems

A preferred example of the invention is a diagnosis system for diagnosing a monitoring target instrument using a computer having a processor and a memory, wherein the processor is configured to receive operation data including control periodically performed on the monitoring target instrument and a running time of the instrument operated in accordance with the control, and diagnose an abnormality in the instrument in an inefficient operation state based on a determination as to whether or not the control included in the operation data and the running time of the instrument satisfy a predetermined relationship.

### Effects of the Invention

According to the invention, it is possible to diagnose an abnormality in an instrument in an inefficient operation state from operation data of the instrument.

### BRIEF DESCRIPTION OF THE DRAWINGS

FIG. 1 is a configuration diagram illustrating a monitoring system of this embodiment.

FIG. 2 is a diagram illustrating a configuration of a compressor.

FIG. 3 is a diagram illustrating an information communication device.

FIG. 4 is a diagram illustrating a configuration example of an instrument information database.

FIG. 5 is a diagram illustrating a configuration example of a customer information database.

FIG. 6 is a diagram illustrating a configuration example of an operation data management table.

FIG. 7 is a diagram illustrating an operational flow of this embodiment.

FIG. 8 is a diagram illustrating an operational flow of a compressor diagnosis process.

FIG. 9 is a diagram illustrating an operational flow of a compression process.

FIG. 10 is a diagram illustrating an output example of data visualization.

FIG. 11 is a diagram illustrating a configuration example of comparison data.

### MODE FOR CARRYING OUT THE INVENTION

Hereinafter, an embodiment of the invention will be described with reference to the drawings. The following description and drawings are examples for describing the invention, and appropriate omissions and simplifications have been made for clarity of description. The invention can be implemented in various other forms. Unless otherwise specified, each component may be singular or plural.

In order to facilitate understanding of the invention, a position, size, shape, range, etc. of each component illustrated in the drawings may not represent an actual position, size, shape, range, etc. Therefore, the invention is not necessarily limited to the position, size, shape, range, etc. disclosed in the drawings.

In the following description, various types of information may be described using expressions such as “database”, “table”, and “list”, but the various types of information may be expressed using other data structures. To indicate independence from a data structure, “XX table”, “XX list”, etc. may be referred to as “XX information”. When expressions such as “identification information”, “identifier”, “name”, “ID”, and “number” are used at the time of describing identification information, these expressions are interchangeable.

When there is a plurality of components having the same or similar functions, the components may be described using the same reference numerals with different subscripts. However, when there is no need to distinguish between the plurality of components, the subscripts may be omitted.

In addition, in the following description, processing performed by executing a program may be described. However, the program is executed by a processor (e.g., a CPU (Central Processing Unit) or a GPU (Graphics Processing Unit)) to perform specified processing while appropriately using a storage resource (e.g., a memory) and/or an interface device (e.g., a communication port), etc., and thus a subject of the processing may be the processor. Similarly, the subject of the processing performed by executing the program may be a controller, a device, a system, a calculator, or a node having a processor. The subject of the processing performed by executing a program may be a calculation unit, and may include a dedicated circuit (e.g., an FPGA (Field-Programmable Gate Array) or an ASIC (Application Specific Integrated Circuit)) that performs specific processing.

The program may be installed in a device such as a calculator from a program source. The program source may be, for example, a program distribution server or a storage medium readable by a calculator. When the program source is the program distribution server, the program distribution server may include a processor and a storage resource for storing a program to be distributed, and the processor of the program distribution server may distribute the program to be distributed to other calculators. Further, in the following description, two or more programs may be realized as one program, and one program may be realized as two or more programs.

### (1) Configuration of Diagnosis System According to this Embodiment

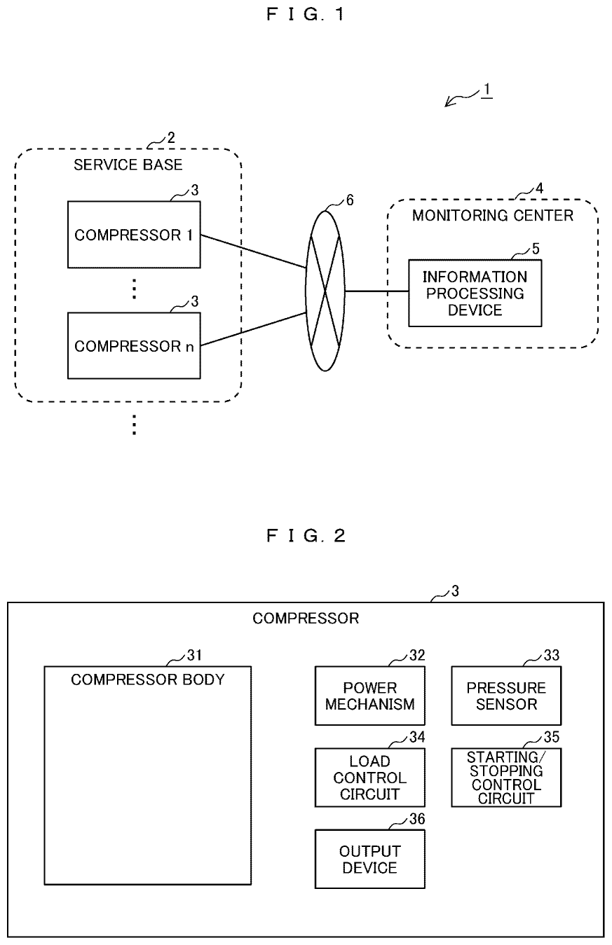

FIG. 1 is a configuration diagram illustrating an example of a monitoring system including a diagnosis system in this embodiment. The monitoring system 1 including the diagnosis system is a system that monitors states of a plurality of monitoring target instruments such as an air compressor. As illustrated in FIG. 1, the monitoring system 1 is configured by connecting a compressor 3, which is an example of one or more monitoring targets installed at one or more service bases 2 such as a factory, and an information processing device 5 installed at a monitoring center 4 that monitors the service bases 2, via a network 6 such as the Internet. In the following, even though a compressor is illustrated as an example of an instrument to be monitored, the invention is applicable to devices (e.g., blowing machines such as fans and blowers) subjected to control related to operation similar to that of the compressor.

Each compressor 3 (in FIG. 1, each of n compressors from compressor 1 to compressor n) transmits information such as the pressure inside each instrument and an accumulated running time up to that point as operation data to the information processing device 5 periodically or irregularly via the network 6. In addition, when any measured value becomes greater than ore qual to a threshold value, when a failure occurs, when repair or inspection is performed, etc., the compressor 3 transmits an alarm or notification according to content thereof to the information processing device 5 via the network 6.

FIG. 2 is a diagram illustrating a configuration of the compressor 3. The compressor 3 is a device that discharges compressed air. As illustrated in FIG. 2, the compressor 3 includes a compressor body 31 which is a main mechanism of the compressor 3, a power mechanism 32 which is a power source for driving the compressor body 31, a pressure sensor 33 that detects and measures the discharge pressure which is the pressure of the air discharged by the compressor 3, a load control circuit 34 that performs load control to control the discharge pressure output by the compressor 3 so that the discharge pressure is equal to or greater than the lower limit pressure and equal to or less than the upper limit pressure by switching between loaded operation and unloaded operation performed by the compressor 3, a starting/stopping control circuit 35 that performs starting/stopping control so that the compressor 3 is stopped when the unloaded operation continues for a predetermined time or more and the compressor 3 is restarted when the discharge pressure becomes a predetermined value or less, and an output device 36 that outputs air compressed by the compressor body 31.

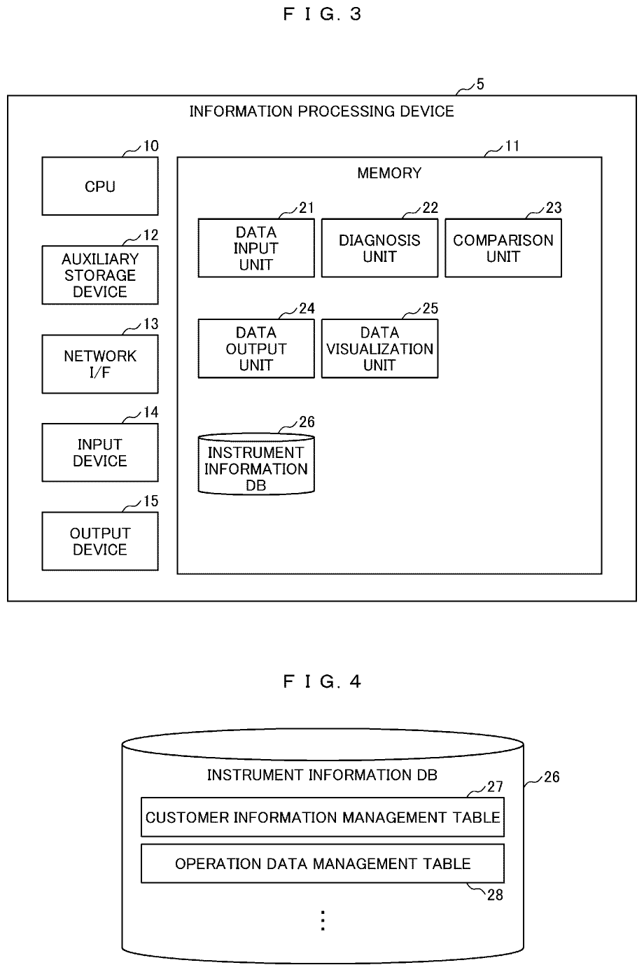

FIG. 3 is a diagram illustrating an information communication device 5. The information processing device 5 is a server having a function of monitoring and diagnosing an instrument state of each compressor 3, and is a server included in the above-mentioned diagnosis system. As illustrated in FIG. 3, the information processing device 5 includes a CPU 10, a memory 11, an auxiliary storage device 12, a network interface 13, an input device 14, and an output device 15.

The CPU 10 is a processor that controls the overall operation of the information processing device 5. In addition, the memory 11 includes a ROM (Read Only Memory) (not illustrated) having a nonvolatile storage element, and a RAM (Random Access Memory) (not illustrated) having a volatile storage element. The ROM stores an unchanging program such as a BIOS (Basic Input Output System). In addition, the RAM includes a DRAM (Dynamic RAM) and is used as a working memory for the CPU 10. Information stored in the memory 11 will be described later.

The auxiliary storage device 12 includes a large-capacity nonvolatile storage device such as a hard disk device or an SSD (Solid State Drive). Various programs and various data to be stored for a long period of time are stored in the auxiliary storage device 12. The programs and data stored in the auxiliary storage device 12 are loaded from the auxiliary storage device 12 to the memory 11 when an analysis server is started or as necessary. The CPU 10 executes the programs loaded into the memory 11, thereby executing various processes of the information processing device 5 as a whole, as described below.

The network interface 13 includes, for example, a NIC (Network Interface Card), and functions as an interface using communication with each compressor 3 to be monitored via the network 6 (FIG. 1).

The input device 14 includes, for example, a mouse, a keyboard, etc., and is used by a user to input various operations to the information processing device 5. In addition, the output device 15 includes, for example, a liquid crystal panel, an organic EL (Electro-Luminescence) display, and/or a printer, and is used to display necessary information or output the necessary information by printing, etc. Note that the input device 14 and the output device 15 may be configured as a touch panel, etc. obtained by integrating these devices.

Various data stored in this system or used for processing can be realized by the CPU reading the data from the memory or a storage device and using the data. In addition, each functional unit (e.g., a data input unit 21, a diagnosis unit 22, a comparison unit 23, a data output unit 24, a data visualization unit 25) can be realized by the CPU loading a predetermined program stored in the storage device into the memory and executing the program.

The above-mentioned predetermined program may be stored (downloaded) into the storage device from the storage medium or from the network, then loaded into the memory, and executed by the CPU. In addition, the program may be directly loaded into the memory from the storage medium or from the network via the communication device, and then executed by the CPU.

In the following, the functions of this system are illustrated as being performed by one server. However, all or some of these functions may be distributed and provided across one or more computers, such as a cloud, and the same function may be realized by mutual communication via a network. A specific process performed by each unit of this system will be described later using a flowchart.

Next, a description will be given of the information stored in the memory 11. As illustrated in FIG. 3, the memory 11 has the data input unit 21, the diagnosis unit 22, the comparison unit 23, the data output unit 24, the data visualization unit 25, and the instrument information DB 26. Each of these units has software executable by the CPU 10, such as a program or a module.

FIG. 4 is a diagram illustrating a configuration example of an instrument information DB (database). The instrument information DB 206 has a customer information management table 27 and an operation data management table 28.

FIG. 5 is a diagram illustrating a configuration example of the customer information management table. The customer information management table 27 is a table for managing users such as companies and organizations that use the compressor 3 in the service base 2. As illustrated in FIG. 5, the customer information management table 27 records a customer name 27A indicating a name of a user who uses the compressor 3, an installation location 27B indicating an installation location of the compressor 3, a serial number 27C for identifying the compressor 3, and a model type 27D indicating a type of the compressor 3. For example, FIG. 5 illustrates that a compressor 3 identified by a serial number “XXX1234” and a model type “model A” is installed in a service base 2 of “XX Prefecture, OO City” in “corporation A” which is a company. Here, one compressor 3 is illustrated as an example. However, compressors 3, the number of which corresponds to the size and environment of the service base 2, is registered.

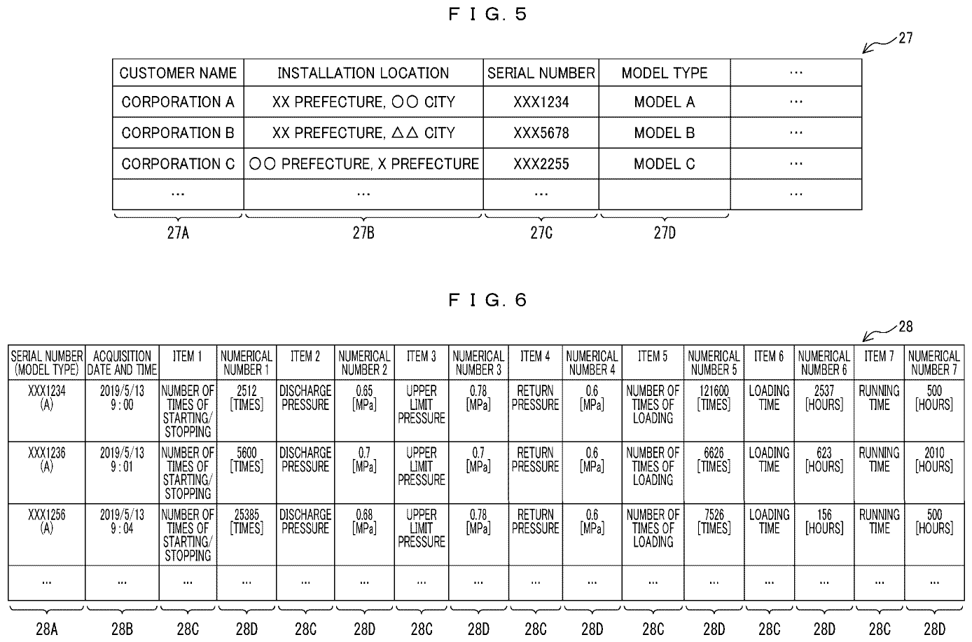

FIG. 6 is a diagram illustrating a configuration example of the operation data management table. The operation data management table 28 is a table for managing operation data indicating operation results of the compressor 3. As illustrated in FIG. 6, the operation data management table 28 records the above-mentioned serial number (and model type) 28A, acquisition date and time of operation data 28B, items (1 to n) included in the operation data 28C, and numerical values (1 to n) of the items 28D. For example, FIG. 6 illustrates that a compressor 3 identified by a serial number “XXX1234 (model type: model A)” acquires operation data including respective items and numbers such as the number of times of starting/stopping “2512”, the discharge pressure “0.65” MPa, the upper limit pressure “0.78” MPa, the return pressure “0.6” MPa, the number of times of loading “121600”, a loading time “2537” hours, and a running time “500” hours at “2019/5/13 9:00”.

The value of each of these items is obtained from each part of the compressor 3 illustrated in FIG. 2. For example, the number of times of starting/stopping is the number of times that the compressor 3 is started and stopped under starting/stopping control, which is recorded by the starting/stopping control circuit 35. In addition, the discharge pressure is the discharge pressure output by the compressor 3 by switching between the loaded operation and the unloaded operation performed by the compressor 3, which is recorded by the load control circuit 34. The upper limit pressure is an upper limit value of the discharge pressure, which is set by the load control circuit 34. In addition, the return pressure is the discharge pressure required to reach a lower limit of the discharge pressure in a started state, which is set by the load control circuit 34. The number of times of loading is the number of times that the compressor body 31 is restarted and the discharge pressure becomes greater than or equal to the lower limit, which is recorded by the load control circuit 34. In addition, the loading time is a time during which the compressor 3 is restarted and the discharge pressure becomes greater than or equal to the lower limit, which is recorded by the load control circuit 34. The running time is a time during which the starting/stopping control compressor 3 is started, which is recorded by the starting/stopping control circuit 35.

The compressor 3 performs load control so that the output discharge pressure becomes greater than or equal to the lower limit pressure and less than or equal to the upper limit pressure by switching between the loaded operation and the unloaded operation, and performs starting/stopping control to stop operation when the unloaded operation continues for a predetermined time or more and restart the operation when the discharge pressure becomes less than or equal to a predetermined value. The load control and the starting/stopping control are controls repeatedly performed during the operation of the compressor. In this embodiment, operation data related to the periodic operation state of the compressor 3 is recorded in the operation data management table 28. For this reason, in FIG. 6, for example, in the case of the compressor having the serial number “XXX1234 (model type: model A)”, the number of times of starting/stopping, the discharge pressure, the upper limit pressure, the return pressure, the number of times of loading, the loading time, and the running time in a certain period starting from “2019/5/13 9:00” are recorded. For example, the input unit 30 may store these values in the operation data management table 28 by performing statistical processing (for example, calculation of an average value, aggregation of running times in the above-mentioned certain period, etc.) on operation data received from the compressor 3.

As described above, in this embodiment, control patterns are analyzed for control repeatedly performed in the operation of the compressor such as the starting/stopping control and the load control. Then, according to a result of the analysis, for example, for a compressor that is operating inefficiently, improvement measures are proposed to promote energy saving for the compressor, such as changing the frequency of performing such control. An example of the inefficient operation is an operation in which values of various operation data obtained in the starting/stopping control and the load control (in FIG. 6, numerical values 1 to 7 for items 1 to 7) are outside a predetermined range. Then, proposal is made to review settings and reduce unnecessary driving for control such as pressure setting or driving (redriving) periodically performed on the compressor. Specific processing will be described below.

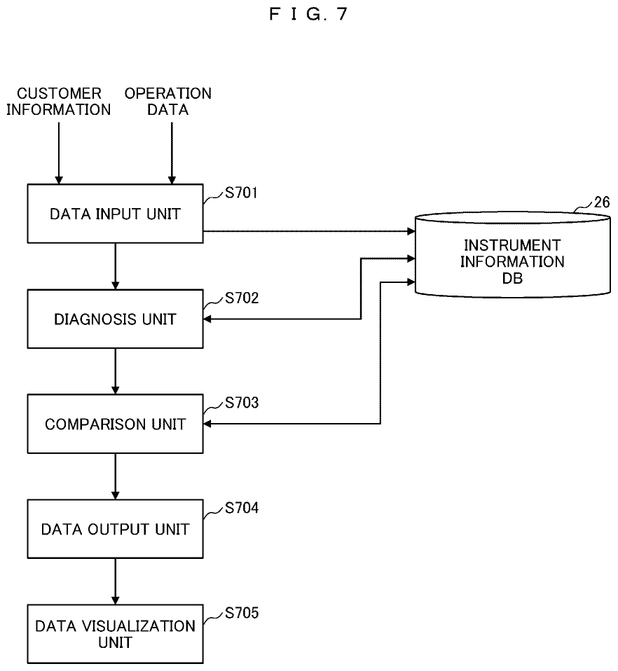

FIG. 7 is a diagram illustrating an operational flow of this embodiment. The data input unit 21 receives customer information and operation data from each compressor 3 arranged in the service base 2 illustrated in FIG. 1. The data input unit 21 stores the input customer information and operation data in the instrument information DB 26 and outputs the input customer information and operation data to the diagnosis unit 22 (S701). Specifically, the data input unit 21 stores the customer information in the customer information management table 27 and stores the operation data in the operation data management table 28.

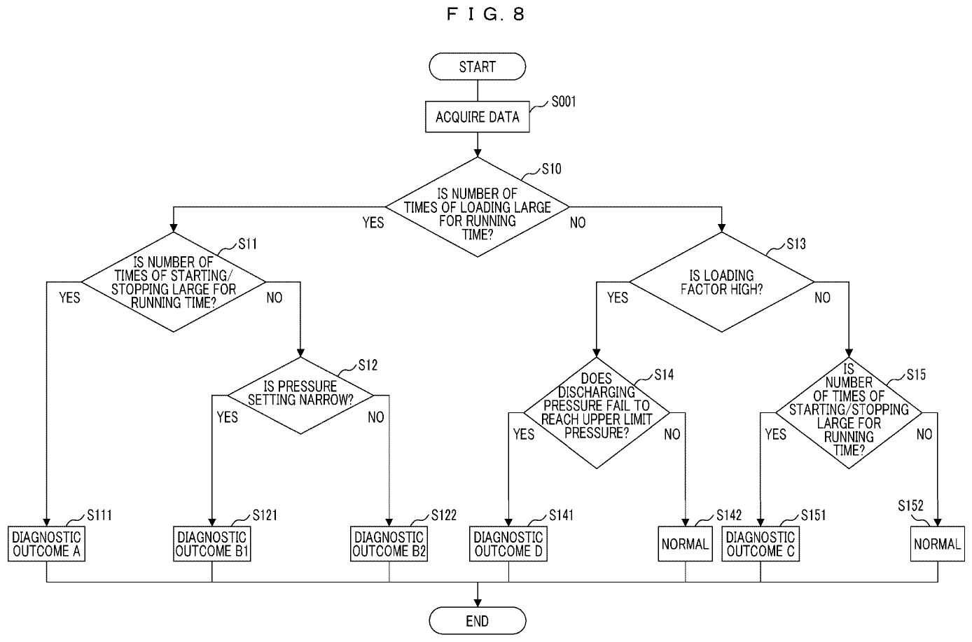

The diagnosis unit 22 acquires information associated with the customer information stored in the instrument information DB 26 (S702). Specifically, the diagnosis unit 22 determines a diagnostic outcome according to the operational flow of the compressor diagnosis process illustrated in FIG. 8, and outputs the customer information and the diagnostic outcome to the comparison unit 23.

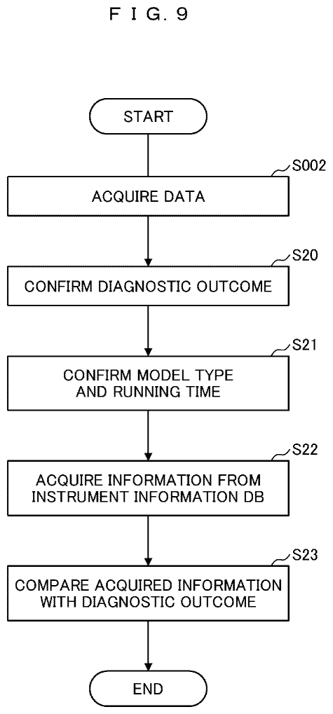

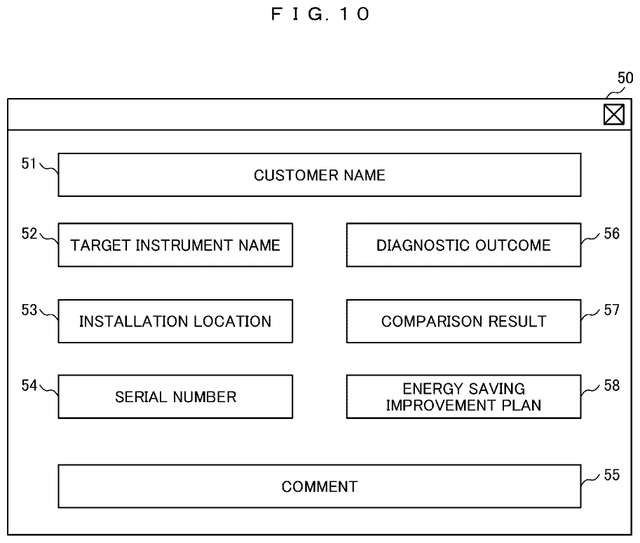

The comparison unit 23 outputs the customer information, the operation data, the diagnostic outcome, and the comparison result to the data output section 24 in accordance with the operational flow of the compression process illustrated in FIG. 9 (S703).

The data output unit 24 outputs visualized content to the data visualization unit 25 according to the customer information, the operation data, the diagnostic outcome, and the comparison result acquired from the comparison unit 23 (S704).

The data visualization unit 25 outputs the customer information, the operation data, the diagnostic outcome, and the comparison result acquired from the data output unit 24 as output results including a customer name 51, a target instrument name 52, an installation location 53, a serial number 54, a comment 55, a diagnostic outcome 56, a comparison result 57, and an energy saving improvement plan 58, as illustrated in FIG. 10 (S705). The output results may be in the form of a printed matter such as a report output from a printing device such as a printer (not illustrated), or may be in the form of a display on a browser output to a screen of the output device 15.

FIG. 8 is a diagram illustrating an operational flow of the compressor diagnosis process. As described above, the diagnosis unit 22 acquires a customer name 27A, an installation location 27B, a serial number 27C, and a model type 27D stored in the customer information management table 27 of the instrument information DB 26, and a serial number 28A, an acquisition date and time 28B, items (1 to n) 28C, and numerical values (1 to n) 28D stored in the operation data management table 28 (S001). Specifically, when data matching the acquired customer information in the data stored in the customer information management table 27 is data in which the customer name is “corporation A”, the installation location is “XX Prefecture, OO City”, the serial number is “XXX1234”, and the model type is “model A”, the diagnosis unit 22 reads this information and acquires this information as data associated with the serial number “XXX1234” and the model type “model A” from the operation data management table 28. For example, the diagnosis unit 22 acquires data in which the acquisition date and time is “2019/5/13 9:00”, the number of times of starting/stopping is “2512”, the discharge pressure is “0.65” MPa, the upper limit pressure is “0.78” MPa, the return pressure is “0.6” MPa, the number of times of loading is “121600”, the loading time is “2537” hours, and the running time is “500” hours.

The diagnosis unit 22 determines whether or not the number of times of loading is large relative to the acquired operation data and running time (S10). When the number of times of loading is larger than a predetermined determination criterion (the number of times of loading/the running time>83.33 [times/hour]) (S10; YES), the diagnosis unit 22 further determines whether or not the number of times of starting/stopping is large relative to the running time (the number of times of starting/stopping/the running time≥3 [times/hour]) (S11). In S11, it is determined whether or not the number of times of loading is large relative to the running time. However, it is possible to determine whether the loading time is large relative to the running time. In this case, it is sufficient to made a determination based on whether or not a predetermined determination criterion (loading time/running time) is equal to or greater than a predetermined threshold value.

When determining that the number of times of starting/stopping is large relative to the running time (S11; YES), the diagnosis unit 22 determines that a result is a diagnostic outcome A (insufficient capacity of an air tank) and outputs the result (S111). On the other hand, when determining that the number of times of starting/stopping is not large relative to the running time (S11; NO), the diagnosis unit 22 further determines whether or not the pressure setting is narrow (less than 0.10 MPa, which is a width serving as a threshold value) (S12).

When determining that the pressure setting is narrow (S12; YES), the diagnosis unit 22 determines that a result is a diagnostic outcome B1 (improvement of pressure setting) and outputs the result (S121). On the other hand, when determining that the pressure setting is not narrow (S12; NO), the diagnosis unit 22 determines that a result is a diagnostic outcome B2 (filter clogging) and outputs the result (S122).

When determining that in S10 that the acquired operation data acquired is not greater than the above-mentioned predetermined determination criterion (S10; NO), the diagnosis unit 22 further determines whether or not a loading factor is high (S13).

When determining that the loading factor is greater than a predetermined determination criterion (average loading factor≥50 [%/day]) (S13; YES), the diagnosis unit 22 further determines whether or not the discharge pressure has reached the upper limit pressure (S14). When determining that the discharge pressure has reached the upper limit pressure (S14; YES), the diagnosis unit 22 determines that a result is a diagnostic outcome is D (insufficient specifications of the compressor) and outputs the result (S141). On the other hand, when determining that the discharge pressure has not reached the upper limit pressure (S14; NO), the diagnosis unit 22 determines that the discharge pressure is normal and outputs the result (S142).

In addition, when determining in S13 that the loading factor is not greater than the predetermined determination criterion (S13; NO), the diagnosis unit 22 further determines whether or not the number of times of starting/stopping is large relative to the running time (S15). When determining that the number of times of starting/stopping is greater than the predetermined determination criterion (the number of times of starting/stopping/the running time≥3 [times/hour]) (S15; YES), the diagnosis unit 22 determines that a result is a diagnostic outcome C (there is a possibility of air leakage) and outputs the result (S151). On the other hand, when determining that the number of times of starting/stopping is not greater than the above-mentioned predetermined determination criterion (S15; NO), the diagnosis unit 22 determines a result is normal and outputs the result (S152).

Specifically, in the case of the compressor 3 identified by the serial number “XXX1234”, the number of times of starting/stopping is “2512”, the discharge pressure is “0.65” MPa, the upper limit pressure is “0.78” MPa, the return pressure is “0.6” MPa, the number of times of loading is “121600”, the loading time is “2537” hours, and the running time is “500” hours. For this reason, in this process, the number of times of loading/running time=243.2 [times/hour] (YES in S10), and the number of times of starting/stopping/the running time=5.24 [times/hour] (YES in S11), and the diagnosis unit 22 determines that the result is the diagnostic outcome A (insufficient capacity of the air tank).

FIG. 9 is a diagram illustrating an operational flow of the compression process. As described above, the comparison unit 23 acquires a diagnostic outcome from the diagnosis unit 22, and acquires information based on the diagnostic outcome and the customer information acquired from the diagnosis unit 22 from the instrument information DB 26 (S002).

The comparison unit 23 confirms the diagnostic outcome acquired from the diagnosis unit 31 (S20), and confirms the model type and the running time (S21). Since the compressor 3 is operated by periodically repeating control such as starting and stopping, the comparison unit 23 confirms the running time when the compressor is running during a specified period.

The comparison unit 23 acquires, from the instrument information DB 26, operation data having a matching model type and approximately the same running time as a comparison target (S22). For example, approximately the same running time means being within a predetermined range (±50 hours) of the running time of the compressor serving as a diagnosis target.

The comparison unit 23 acquires the diagnostic outcome by executing the compressor diagnosis process described above, compares the acquired diagnostic outcome with the operation data acquired in S22, and outputs the comparison result (S23). For example, the comparison unit 23 compares the operation data of the compressor 3 (comparison target A) acquired as the comparison target in S22 with the operation data of the compressor 3 from which the diagnostic outcome confirmed in S20 has been obtained. Upon comparing the operation data of the compressor 3 from which the diagnostic outcome confirmed in S20 has been obtained with the operation data of the comparison target A, the comparison unit 23 outputs the comparison result indicating that a “normal” diagnostic outcome has been obtained even though the running time of the compressor 3 from which the diagnostic outcome has been obtained is “550” hours and is 50 hours longer than that of the comparison target A. Alternatively, upon comparing the operation data of the compressor 3 from which the diagnostic outcome confirmed in S20 has been obtained with operation data of another compressor (comparison target B) acquired as the comparison target in S22, the comparison unit 23 outputs a comparison result indicating that the running time of the compressor 3 during which the diagnostic outcome has been obtained is “450” hours and is 50 hours less than that of the comparison target A, but a diagnostic outcome “filter clogging” has obtained.

FIG. 10 is a diagram illustrating an example of a screen that visualizes data output in this embodiment. A screen configuration 50 of the screen includes the customer name 51, the target instrument name 52, the installation location 53, the serial number 54, the comment 55, the diagnostic outcome 56, the comparison result 57, and the energy saving improvement plan 58.

The customer name 51 is a region for displaying a customer name included in customer information input in S701 and output from the data output unit 24. In this region, for example, the customer name “corporation A” is displayed.

The target instrument name 52 is a region that displays the serial number of the compressor 3 included in the customer information. For example, the serial number “XXX1234” is displayed in this region. In this case, instead of the serial number, a model type linked to the serial number or a product name (not illustrated) may be displayed.

The installation location 53 is a region that displays a location where the compressor 3 included in the customer information is installed. For example, the installation location “XX Prefecture, OO City” is displayed in the region.

The serial number 54 is a region that displays the serial number of the compressor 3 included in the customer information. For example, the serial number “XXX1234” is displayed in this region.

The comment 55 is a region that is input when a system administrator, etc., confirms the diagnostic outcome or the comparison result on the screen. For example, the administrator viewing the diagnostic outcome or the comparison result inputs a comment such as a time to respond to these results “Replacement until O month X day is desirable” based on past experience. The data visualization unit 25 records the input comment in association with data including, for example, the customer name “corporation A”, the installation location “XX prefecture, OO city,” and the serial number “XXX1234” stored in the customer information management table 27. In this way, a person in charge of the compressor 3 can easily determine the timing and policy to be taken for the customer.

The diagnostic outcome 56 is a region that displays a result of the compressor diagnosis process illustrated in FIG. 8. In this region, for example, a statement such as “the diagnostic outcome A (insufficient capacity of the air tank)” is displayed.

The comparison result 57 is a region that displays a result of the compression process illustrated in FIG. 9. As described in S23, for example, a comparison result “The running time is “550” hours and is 50 hours longer than that of the comparison target A, but the diagnostic outcome is “normal”” is displayed in this region.

The energy saving improvement plan 58 is a region that displays advice for improving energy efficiency and saving energy to the compressor 3 receiving the diagnostic outcome 56 or the comparison result 57. For example, statements such as “Lower the upper limit of the pressure” and “Reduce unnecessary driving” are displayed in this region. The manager may associate the statements with the diagnostic outcome and the comparison result in advance and store the advice in the instrument information DB 26 as improvement plan data (not illustrated), and the diagnosis unit 22 and the comparison unit 23 may read the improvement plan data and store the improvement plan data as comparison data described later.

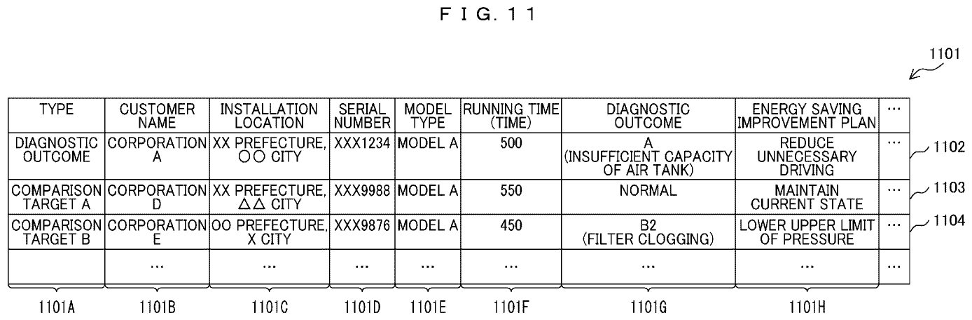

FIG. 11 is a diagram illustrating an example of comparison data used by the comparison unit 23 in the compression process in S23 illustrated in FIG. 9. The comparison data is a work table for the comparison unit 23 to compare the operation data of the compressor receiving the diagnostic outcome with operation data of a compressor having the same model type and running time as those of the compressor in S23 illustrated in FIG. 9. The comparison data is created by the diagnosis unit 22 or the comparison unit 23 each time the compressor diagnosis process illustrated in FIG. 8 or the compression process illustrated in FIG. 9 is executed.

As illustrated in FIG. 11, comparison data 1101 includes a record 1102 which is comparison data for compressor 3 which is the diagnosis target output as the diagnostic outcome, and records 1103 and 1104 which are comparison data for the compressor 3 which is the comparison target output as the comparison result. These records include a type 1101A, a customer name 1101B, an installation location 1101C, a serial number 1101D, a model type 1101E, a running time 1101F, a diagnostic outcome 1101G, and an energy saving improvement plan 1101H. The type 1101A is information for identifying whether the compressor is a diagnosis target or a comparison target. In addition, the customer name 1101B, the installation location 1101C, the serial number 1101D, the model type 1101E, the running time 1101F, the diagnostic outcome 1101G, and the energy saving improvement plan 1101H are the same information as that illustrated in FIG. 5 or FIG. 6, and are each information acquired in the compressor diagnosis process of FIG. 8 or the compression process of FIG. 9.

In FIG. 11, for example, it can be seen that the record 1102 for the compressor having the serial number “XXX1234” serving as a diagnosis target, and the records 1103 and 1104 for two compressors having serial numbers “XXX9988” and “XXX9876” serving as comparison targets are stored in the comparison data 1101 as data to be output. The data output unit 24 outputs the comparison data 1101 to the data visualization unit 25, then the data visualization unit 25 outputs the screen illustrated in FIG. 10 to the output device 15, and the energy saving improvement plan for the diagnostic outcome is presented. In this example, it can be seen that the energy saving improvement plan of “reduce unnecessary driving” is presented since the diagnostic outcome of the compressor having the serial number “XXX9988” serving as a diagnosis target is “insufficient capacity of the air tank”.

In this way, the data output unit 24 reads the comparison data including the diagnostic outcome stored by the diagnosis unit 22 and the comparison unit 23, and outputs the comparison data to the data visualization unit 25 together with the customer information input in S701. Furthermore, the data visualization unit 25 outputs the data received from the data output unit 24 to the output device 15, thereby displaying the screen illustrated in FIG. 10. In this way, it is possible to extract and visualize an instrument in an inefficient operation state from operation data of instruments.

As described above, referring to the diagnosis system in this embodiment, as described using S702 of FIG. 7, FIG. 8, etc., in a diagnosis system that diagnoses a monitoring target instrument (e.g., a compressor or a blowing machine) using a computer (information processing device 5) having a processor and a memory, the processor receives operation data including control periodically performed on the monitoring target instrument (e.g., control on the instrument such as load control or starting/stopping control described below) and the running time of the instrument operated in accordance with the control, and diagnoses an abnormality in the instrument in the inefficient operation state based on a determination as to whether or not the control included in the operation data and the running time of the instrument satisfy a predetermined relationship (e.g., in the case of the compressor, processing of S10 and S11 of FIG. 8). In this way, from the operation data of the instrument, it is possible to diagnose an abnormality of the instrument in the inefficient operation state. As a result, it becomes possible to efficiently operate the instrument while taking into account a viewpoint of energy saving.

In addition, as described in S702 of FIG. 7, FIG. 8, etc., the monitoring target instrument includes the compressor (compressor 3), the operation data (each record of the operation data management table 28) includes information related to control of the compressor related to load control for controlling the pressure output by the compressor so that the pressure becomes greater than or equal to the lower limit pressure and less than or equal to the upper limit pressure by switching between the loaded operation and the unloaded operation performed by the compressor, and starting/stopping control for stopping the compressor when the unloaded operation continues for a predetermined time or more and restarting the compressor when the pressure becomes less than or equal to a predetermined value, and the processor diagnoses an abnormality of the compressor based on at least one of the number of times of loading of performing the loaded operation and the unloaded operation included in the operation data, or the number of times of starting/stopping of restarting by stopping the power that drives the compressor, and the running time of the compressor. In this way, when the monitoring target instrument is the compressor, it is possible to diagnose an abnormality of the instrument in the inefficient operation state.

In addition, as described in S11; YES of FIG. 8, the diagnostic outcome A, etc., when the number of times of starting/stopping with respect to the running time satisfies a predetermined condition (for example, the number of times of starting/stopping/the running time≥3 [times/hour]), the processor diagnoses the insufficient capacity of the air tank included in the compressor. In this way, when the number of times of starting/stopping with respect to the running time satisfies the predetermined condition (for example, the number of times of starting/stopping/the running time≥3 [times/hour]), it is possible to report an abnormality which is the insufficient capacity of the air tank.

In addition, as described in S13 and S14 of FIG. 8, the diagnostic outcome D, etc., when an average daily loading factor of the compressor included in the operation data is greater than or equal to a certain level (for example, the average loading factor≥50 [%/day]), and the discharge pressure does not reach the upper limit pressure (for example, “0.78” Mpa), the processor diagnoses insufficient specifications of the compressor. In this way, when the average daily loading factor of the compressor is greater than or equal to the certain level, and the discharge pressure does not reach the upper limit pressure, it is possible to report an abnormality which is the insufficient specifications of the compressor.

In addition, as described in S10; YES and S11 of FIG. 8, etc., when the number of times of loading with respect to the running time is greater than or equal to a certain level (for example, the number of times of loading/the running time≥83.33 [times/hour]), the processor makes a determination related to the number of times of starting/stopping. In this way, when the number of times of loading with respect to the running time is greater than or equal to the certain level, it is possible to make a determination related to the number of times of starting/stopping, and to efficiently make a determination related to the number of times of starting/stopping.

In addition, as described in S12; YES of FIG. 8, the diagnostic outcome B1, etc., when the number of times of starting/stopping with respect to the running time does not satisfy a predetermined condition, and when pressure setting of the compressor is narrower than a predetermined threshold value by a certain value or more (for example, when the pressure setting is less than 0.10 MPa, which is a width of the threshold value), the processor diagnoses that the pressure setting needs to be improved. In this way, when the number of times of starting/stopping with respect to the running time does not satisfy the predetermined condition, and the pressure setting of the compressor is narrower than the predetermined threshold value by the certain value or more, it is possible to urge that the pressure setting needs to be improved.

In addition, as described in S12; NO of FIG. 8, the diagnostic outcome B2, etc., when the number of times of starting/stopping with respect to the running time does not satisfy the predetermined condition, and when the pressure setting of the compressor is not narrower than the predetermined threshold value by the certain value or more, the processor diagnoses filter clogging. In this way, when the number of times of starting/stopping with respect to the running time does not satisfy the predetermined condition, and the pressure setting of the compressor is not narrower than the predetermined threshold value by the certain value or more, it is possible to report an abnormality which is filter clogging.

In addition, as described in S15; YES, the diagnostic outcome C, etc., when an average daily loading factor of the compressor included in the operation data is not greater than or equal to a certain level, and the number of times of starting/stopping with respect to the running time satisfies a predetermined condition (for example, the number of times of starting/stopping/the running time≥3 [times/hour]), the processor diagnoses that there is a possibility of air leakage from the compressor. In this way, when the average daily loading factor of the compressor included in the operation data is not greater than or equal to the certain level, and the number of times of starting/stopping with respect to the running time satisfies the predetermined condition, it is possible to report an abnormality which is a possibility of air leakage from the compressor.

In addition, as described in S10 of FIG. 8, etc., the processor may determine whether or not the loading time with respect to the running time is greater than or equal to a certain level instead of the number of times of loading with respect to the running time. In this way, when the loading time with respect to the running time is greater than or equal to the certain level, it is possible to make a determination related to the number of times of starting/stopping, and similarly to the case of the number of times of loading, it is possible to efficiently make a determination related to the number of times of starting/stopping.

In addition, as described in FIGS. 9, 10, and 11, etc., the processor compares the operation data of the compressor whose operation state is similar to that of the compressor subjected to abnormality diagnosis by a certain degree with the operation data of the compressor subjected to the abnormality diagnosis, and displays a screen including a result of the comparison, a result of the diagnosis, and a predetermined improvement plan based on the diagnosis on a display device (output device 15). In this way, it is possible to present an improvement plan according to a diagnostic outcome for an instrument in an inefficient operation state and a comparison result with another similar instrument.

### REFERENCE SIGNS LIST

1 Monitoring system
2 Service base
3 Compressor
4 Monitoring center
5 Information processing device (diagnosis system)
25 Instrument information DB
21 Data input unit
22 Diagnosis unit
23 Data output unit
24 Data visualization unit

1. A diagnosis system for diagnosing a monitoring target instrument using a computer having a processor and a memory,
wherein the processor is configured to:
receive operation data including control periodically performed on the monitoring target instrument and a running time of the instrument operated in accordance with the control, and
diagnose an abnormality in the instrument in an inefficient operation state based on a determination as to whether or not the control included in the operation data and the running time of the instrument satisfy a predetermined relationship.

2. The diagnosis system according to claim 1, wherein:
the monitoring target instrument includes a compressor,
the operation data includes information related to control of the compressor related to load control for controlling a pressure output by the compressor so that the pressure becomes greater than or equal to a lower limit pressure and less than or equal to an upper limit pressure by switching between a loaded operation and an unloaded operation performed by the compressor, and starting/stopping control for stopping the compressor when the unloaded operation continues for a predetermined time or more and restarting the compressor when the pressure becomes less than or equal to a predetermined value, and
the processor diagnoses an abnormality of the compressor based on at least one of a number of times of loading of performing the loaded operation and the unloaded operation included in the operation data, or a number of times of starting/stopping of restarting by stopping power for driving the compressor, and a running time of the compressor.

3. The diagnosis system according to claim 2, wherein, when the number of times of starting/stopping with respect to the running time satisfies a predetermined condition, the processor diagnoses insufficient capacity of an air tank included in the compressor.

4. The diagnosis system according to claim 2, wherein, when an average daily loading factor of the compressor included in the operation data is greater than or equal to a certain level, and a discharge pressure does not reach an upper limit pressure, the processor diagnoses insufficient specifications of the compressor.

5. The diagnosis system according to claim 3, wherein, when the number of times of loading with respect to the running time is greater than or equal to a certain level, the processor makes a determination related to the number of times of starting/stopping.

6. The diagnosis system according to claim 2, wherein, when the number of times of starting/stopping with respect to the running time does not satisfy a predetermined condition, and when pressure setting of the compressor is narrower than a predetermined threshold value by a certain value, the processor diagnoses that the pressure setting needs to be improved.

7. The diagnosis system according to claim 2, wherein, when the number of times of starting/stopping with respect to the running time does not satisfy a predetermined condition, and when pressure setting of the compressor is narrower than a predetermined threshold value by a certain value or more, the processor diagnoses filter clogging.

8. The diagnosis system according to claim 2, wherein, when an average daily loading factor of the compressor included in the operation data is not greater than or equal to a certain level, and the number of times of starting/stopping with respect to the running time satisfies a predetermined condition, the processor diagnoses that there is a possibility of air leakage from the compressor.

9. The diagnosis system according to claim 5, wherein the processor determines whether or not a loading time with respect to the running time is greater than or equal to a certain level instead of the number of times of loading with respect to the running time.

10. The diagnosis system according to claim 1, wherein the processor compares operation data of a compressor whose operation state is similar to an operation state of a compressor subjected to diagnosis of the abnormality by a certain degree with the operation data of the compressor subjected to the diagnosis of the abnormality, and displays a screen including a result of the comparison, a result of the diagnosis, and a predetermined improvement plan based on the diagnosis on a display device 11. A processing device for diagnosing a monitoring target instrument, the processing device comprising:
a processor; and
a memory,
wherein the processor is configured to:
receive operation data including control periodically performed on the monitoring target instrument and a running time of the instrument operated in accordance with the control, and
diagnose an abnormality in the instrument in an inefficient operation state based on a determination as to whether or not the control included in the operation data and the running time of the instrument satisfy a predetermined relationship.
